(19) United States
(12) Patent Application Publication
(10) Pub. No.: US 2021/0183245 A1
(43) Pub. Date: Jun. 17, 2021

(54) EMERGENCY VEHICLE NOTIFICATION SYSTEM

(71) Applicant: Raymond R. Ramirez, Pierson, FL (US)

(72) Inventor: Raymond R. Ramirez, Pierson, FL (US)

(21) Appl. No.: 16/717,548

(22) Filed: Dec. 17, 2019

(51) Int. Cl. G08G 1/0965; G08G 1/09; G08G 1/16; B60W 50/14; H04W 4/90

(52) U.S. Cl. CPC G08G 1/0965; G08G 1/092; G08G 1/162; B60W 2050/146; H04W 4/90; B60W 2050/143; B60W 50/14

(57) ABSTRACT

An emergency vehicle notification system includes an emergency vehicle sensor having functionality for detecting a siren or strobe light emanating from an emergency vehicle. A driver notification unit is positioned within the vehicle and provides an audiovisual indication to a driver that an emergency vehicle is approaching. Both the sensor and the notification unit are linked to a controller having a vehicle communication unit. The vehicle communication unit communicates directly with an electronic component of the automobile to allow the controller to issue a warning over the automobiles radio or visual display system.

### TECHNICAL FIELD

The present invention relates generally to automotive safety equipment, and more particularly to a notification system for alerting drivers of the presence of an emergency vehicle.

### BACKGROUND

The statements in this section merely provide background information related to the present disclosure and may not constitute prior art.

Modern automobiles are constructed so as to make the interior cabin as quiet as possible. Indeed, many manufacturers place a premium on the ability to provide a “quiet ride” for the occupants in order to allow for easy conversation and clear listening to onboard systems such as the radio, hands-free telephone and/or televisions, for example.

In this regard, drivers are increasingly relying on their eyes to maintain situational awareness, as they are unable to hear what is occurring outside. Unfortunately, this situation is resulting in increasing instances of drivers being unaware of the presence of an emergency vehicle that is approaching from behind or beside the driver. Indeed, many drivers are unable to hear the emergency sirens until the first responder is next to them. As a result, the driver is unable to react properly and move their automobile out of the way of the emergency vehicle in a timely manner, thus delaying the first responders from reaching their intended destination.

Accordingly, it would be beneficial to provide an emergency vehicle notification system that can provide an audiovisual indication to a driver within an automobile that an emergency vehicle is approaching, so as to overcome the drawbacks described above.

### SUMMARY OF THE INVENTION

The present invention is directed to an emergency vehicle notification system. One embodiment of the present invention can include an emergency vehicle sensor having functionality for detecting a siren or strobe light emanating from an emergency vehicle. A driver notification unit can be positioned within the vehicle and can function to provide an audiovisual indication to a driver that an emergency vehicle is approaching. Both the sensor and the notification unit can be linked to a controller having circuitry for executing the operation.

One embodiment of the present invention further includes a vehicle communication unit that can be position within the controller. The vehicle communication unit can function to communicate directly with an electronic component of the automobile, such as the CAN Bus, for example. The communication unit functioning to allow the controller to issue a warning over the automobiles radio or visual display system.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a simplified block diagram of the emergency vehicle notification system, in accordance with one embodiment of the invention.

FIG. 2 is a perspective view of the emergency vehicle notification system in operation on a vehicle, in accordance with one embodiment of the invention.

FIG. 3 is a perspective view of the emergency vehicle notification system in operation inside a vehicle, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting, but rather to provide an understandable description of the invention.

### Definitions

As described herein, a “unit” means a series of identified physical components which are linked together and/or function together to perform a specified function.

As described herein, the term “removably secured,” and derivatives thereof shall be used to describe a situation wherein two or more objects are joined together in a non-permanent manner so as to allow the same objects to be repeatedly joined and separated.

As described herein, the terms “connector” and “complementary connector” include any number of different elements that work together to repeatedly join two items together in a non-permanent manner. Several non-limiting examples include opposing strips of hook and loop material (i.e. Velcro®), attractively-oriented magnetic elements, flexible strips of interlocking projections with a slider (i.e., zipper), tethers, buckles such as side release buckles, and compression fittings such as T-handle rubber draw latches, hooks, snaps and buttons, for example. Each illustrated connector and complementary connector can be permanently secured to the illustrated portion of the device via a permanent sealer such as glue, adhesive tape, or stitching, for example.

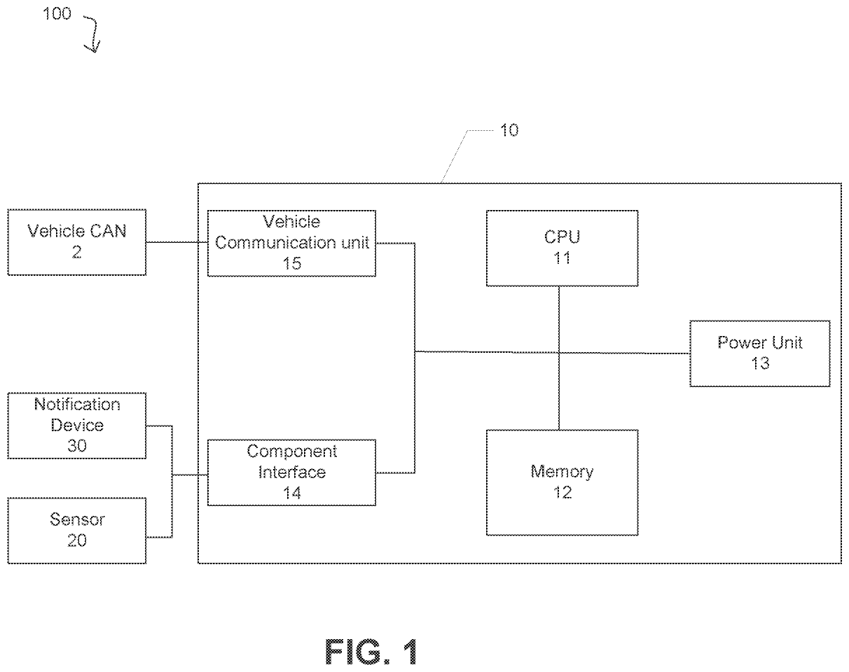

FIGS. 1-3 illustrate one embodiment of an emergency vehicle notification system 100 that is useful for understanding the inventive concepts disclosed herein. As will be described below, the system can be configured to provide an audible and/or visual notification to automobile occupants that an emergency vehicle is approaching.

FIG. 1 is a simplistic block diagram of the system 100 that includes a control unit 10, that is in communication with an emergency vehicle sensor 20, a driver notification device 30 and/or the vehicle itself.

As shown, the controller 10 can include a main body having a processing unit 11 that is conventionally connected to an internal memory 12, a power unit 13, a component interface unit 14 and/or a vehicle communication unit 15.

Although illustrated as separate elements, those of skill in the art will recognize that one or more system components may comprise or include one or more printed circuit boards (PCB) containing any number of integrated circuit or circuits for completing the activities described herein. Of course, any number of other analog and/or digital components capable of performing the below described functionality can be provided in place of or in conjunction with the below described controller elements.

The main body can include any number of different shapes and sizes and can be constructed from any number of different materials suitable for encompassing each of the controller elements. In one preferred embodiment, the main body can be constructed from lightweight injection molded plastic having a plurality of internal connectors for securely housing each of the device elements. Of course, any number of other known construction materials such as PVC and composites, for example, are also contemplated. In either instance, the main body can be secured at any desirable location within or along the vehicle and can preferably be positioned at or adjacent to the vehicle's onboard computer system.

The processing unit 11 can be a conventional central processing unit (CPU) or any other type of device, or multiple devices, capable of manipulating or processing information such as program code stored in the memory 12 and for causing the circuitry to complete the activities and functionality described herein.

The memory 12 can act to store operating instructions in the form of program code for the processor 11 to execute. Although illustrated in FIG. 1 as a single component, memory 12 can include one or more physical memory devices such as, for example, local memory and/or one or more bulk storage devices. As used herein, local memory can refer to random access memory or other non-persistent memory device(s) generally used during actual execution of program code, whereas a bulk storage device can be implemented as a persistent data storage device such as a hard drive, for example, containing programs that permit the processor to perform the mode signaling methods described below. Additionally, memory 12 can also include one or more cache memories that provide temporary storage of at least some program code in order to reduce the number of times program code must be retrieved from the bulk storage device during execution. Each of these devices are well known in the art.

The power unit 13 can include any number of different components capable of providing the necessary power requirements to each element of the notification system. To this end, the power unit can include or comprise any number of different batteries and/or power cables that can be connected to the vehicles onboard electrical system.

The component interface unit 14 can function to provide a communicative link between the controller 10 and various other system components such as the below described emergency vehicle sensor 20 and the notification device 30, for example. In this regard, the component interface unit can include any number of different elements such as one or more wireless transceivers, one or more PIC microcontrollers, internal buses, USB connections and other such components. Of course, any other means for providing one or two-way communication between the controller and other devices are also contemplated.

The vehicle communication unit 15 can include any number of components capable of communicating with a vehicle 1, either directly or over a network. In the preferred embodiment, the communication unit 15 can include, comprise or consist of a Controller Area Network (CAN) Bus transceiver capable of providing two-way communication with the vehicle's CAN 2. Of course, any number of other devices are contemplated for allowing the controller to communicate directly with other portions of the vehicle and/or the vehicle's computer systems.

As will be described below, the communication unit 15 can function to allow the controller 10 to selectively operate certain audiovisual components within the vehicle 1 such as the vehicles radio, warning lights and display screen(s), for example, to notify a driver that an emergency vehicle is approaching upon receiving a signal from the emergency vehicle sensor 20.

The emergency vehicle sensor 20 can include one or more devices capable of detecting the presence of an emergency vehicle as it approaches the automobile 1 to which the system is installed. In one embodiment, the sensor 20 can include, comprise or consist of a siren sensor having an onboard microphone that detects the “yelp” produced by an emergency vehicles siren. One example of a suitable siren sensor includes the SOS IX siren operated sensor that is commercially available from SOS gate. Of course, any number of other devices capable of performing this functionality are also contemplated for use herein.

In one embodiment, the sensor 20 can include, comprise or consist of a strobe light sensor having an onboard photodiode or other type of optical detector that detects the flashing strobe lights produced by an emergency vehicle. One example of a suitable strobe light sensor includes the model FS-2000 emergency vehicle strobe detector that is commercially available from Hoover Fence Co. Of course, any number of other devices capable of performing this functionality are also contemplated for use herein.

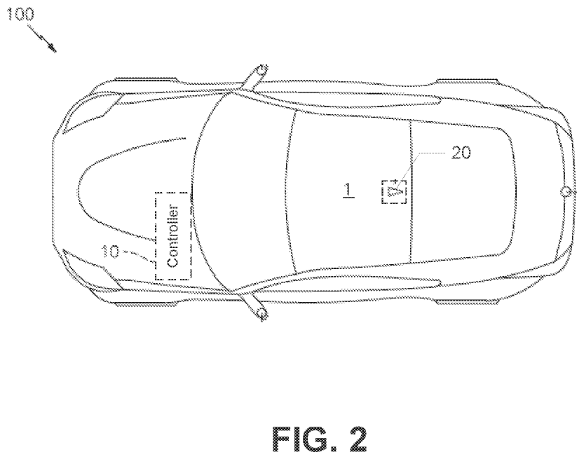

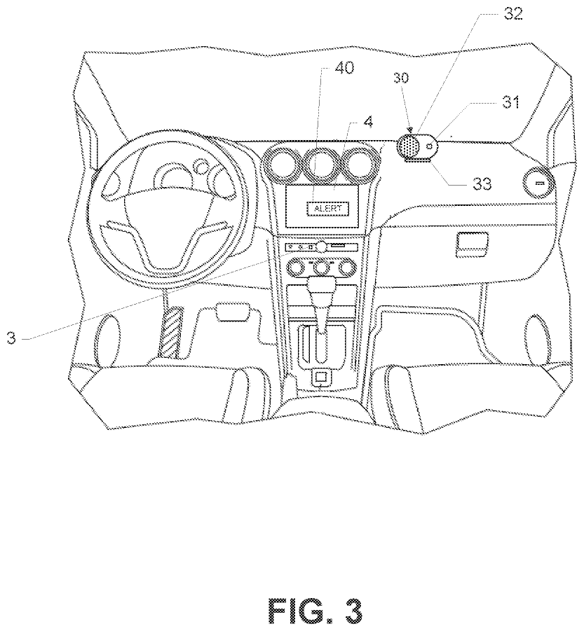

As shown at FIGS. 2 and 3, various components of the system 100 can be installed anywhere along or within an automobile 1. In the preferred embodiment, the sensor(s) 20 can be positioned along the exterior of the vehicle so as to not be affected by the noise quieting measures of the vehicle interior, whereas the controller 10 can be positioned within the vehicle interior.

As shown, one embodiment of the notification device 30 can include, a main body having an integrated light 31 and speaker 32. As described herein, the light 31 can include any number or type of lighting elements, such as an LED light, for example, that can be configured to illuminate in any number of different colors, patterns and intensities. Likewise, the speaker 32 can function to emanate any type of sounds such as a pinging sound, a ringing sound or spoken word sounds, for example.

In one embodiment, the notification device 30 can be communicatively linked to the controller 10 via a physical wire so as to receive operating instructions and power from the controller, or the device 30 can be wirelessly linked to the controller and powered by an onboard battery or separate power cable such as a cigarette lighter adapter, for example. The notification device 30 can also include a connector 33 such as double-sided tape, for example, so as to be positionable anywhere along or within the vehicle so as to be noticeable by the driver.

In either instance, upon detecting the lights and/or siren of an approaching emergency vehicle, the sensor 20 can send a notification signal to the controller 10 which can then selectively activate one or both of the notification device 30 and the vehicle CAN 2.

In this regard, upon receiving a signal from the controller 10, one or both of the light 31 and speaker 32 of the notification device 30 can activate to notify a driver that an emergency vehicle is approaching.

Likewise, upon receiving a signal from the controller 10, the radio 3 of the vehicle can be muted and/or can announce an audible warning, and/or a display 4 within the vehicle can display a visual warning 40 such as a light or icon, for example, to notify a driver that an emergency vehicle is approaching.

Although described above as including both a notification device 30 and a vehicle communication unit 15 for communicating directly with a vehicle computer system, other embodiments are also contemplated. For example, one embodiment of the system 100 can be manufactured for upgrading an existing vehicle, and may omit the communication unit 15, whereas another embodiment of the system 100 can be manufactured as an original component of a new vehicle, and may omit the standalone driver notification unit 30.

As described herein, one or more elements of the emergency vehicle notification system 100 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the terms “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. An emergency vehicle notification system, comprising:
a sensor that is configured to be positioned along an automobile;
a notification device that is configured to be positioned within the automobile, wherein the notification device comprises a main body coupled with the automobile's dashboard; and
a controller having a controller interface that is communicatively directly linked to each of the sensor and the notification device, and a vehicle communication unit that is configured to communicate with a vehicle controller area network independent of the controller interface,
wherein the sensor includes functionality for detecting an emergency vehicle, and the controller includes functionality for selectively activating one or both of the notification device and the vehicle controller area network upon receiving an alert signal from the sensor.

2. The system of claim 1, wherein the sensor includes functionality for detecting a siren from the emergency vehicle.

3. The system of claim 1, wherein the sensor includes functionality for detecting a strobe light from the emergency vehicle.

4. The system of claim 1, wherein the sensor includes functionality for detecting both a siren from the emergency vehicle and a strobe light from aft the emergency vehicle.

5. The system of claim 4, wherein the sensor includes functionality for being mounted to an outside surface of the automobile.

6. The system of claim 1, wherein the main body of the notification device includes an integrated audiovisual component.

7. The system of claim 6, wherein the audiovisual component includes a speaker.

8. The system of claim 6, wherein the audiovisual component includes a light.

9. The system of claim 6, wherein the audiovisual component includes each of a speaker and a light.

10. The system of claim 9, wherein the vehicle communication unit includes functionality for selectively activating an audiovisual component of the automobile upon receiving the alert signal from the sensor.

11. The system of claim 10, wherein the audiovisual component of the automobile comprises a vehicle radio.

12. The system of claim 10, wherein the audiovisual component of the automobile comprises a vehicle light.

13. The system of claim 10, wherein the audiovisual component of the automobile comprises a vehicle display.

14. The system of claim 1, wherein the notification device includes the main body having an integrated audiovisual component, and wherein the vehicle communication unit includes functionality for selectively activating an audiovisual component of the automobile itself.

15. The system of claim 10, wherein the notification device includes functionality for selectively activating one or both of the light and the speaker upon receiving a signal from the controller.

16. The system of claim 15, wherein the notification device is coupled with the automobile's dashboard using a connector.

17. The system of claim 16, wherein the connector is a double-sided tape.
